(19) United States
(12) Patent Application Publication
(10) Pub. No.: US 2024/0302709 A1
(43) Pub. Date: Sep. 12, 2024

(54) WAVELENGTH CONVERTING NATURAL VISION SYSTEM

(71) Applicant: Northwestern University, Evanston, IL (US)

(72) Inventor: Hooman Mohseni, Wilmette, IL (US)

(21) Appl. No.: 18/272,735

(22) PCT Filed: Feb. 1, 2022
(86) PCT No.: PCT/US22/14651

§ 371 Date: Jul. 17, 2023

Related U.S. Application Data
(60) Provisional application No. 63/144,028, filed on Feb. 1, 2021.

(51) Int. Cl. G02F 2/00; G02F 1/01

(52) U.S. Cl. CPC G02F 2/008; G02F 1/0102

(57) ABSTRACT

A wavelength converter includes a first optical layer, a second optical layer, and a pixel array positioned between the first optical layer and the second optical layer. A pixel in the pixel array includes a first device to convert incident invisible light to an electrical signal and a second device that converts the electrical signal into visible light.

### CROSS-REFERENCE TO RELATED APPLICATION

The present application claims the priority benefit of U.S. Provisional Patent App. No. 63/144,028 filed on Feb. 1, 2021, the entire disclosure of which is incorporated herein by reference.

### BACKGROUND

Light, whether it is visible or invisible to the human eye, is a type of wave. Light waves can be thought of as ripples in electric and magnetic fields, and can also be referred to as a type of electromagnetic wave. There is not a fundamental difference between visible light and forms of other invisible light such as infrared waves, microwaves, radio waves, X-rays, gamma rays, etc. Rather, these are all types of electromagnetic waves that differ in wavelength, which refers to the distance from the peak of one wave to the peak of the next. To the human eye, visible light has a wavelength of between ˜400 nanometers (nm) and ˜700 nm. Light with wavelengths outside of this range is generally considered invisible to the human eye.

### SUMMARY

An illustrative wavelength converter includes a first optical layer, a second optical layer, and a pixel array positioned between the first optical layer and the second optical layer. A pixel in the pixel array includes a first device to convert incident invisible light to an electrical signal and a second device that converts the electrical signal into visible light. The first optical layer can be configured to receive the incident invisible light, and the second optical layer can be configured to output the visible light.

In an illustrative embodiment, the system also includes a battery connected to the pixel array, where one or more of the first device and the second device of the pixel is powered by the battery. In one embodiment, the first optical layer is made of one or more elements that convert a direction of the incident invisible light to a specific pixel in the pixel array. The one or more elements can be one or more lenses. In another embodiment, the second optical layer is used to convert a point of light to a collimated beam with a direction that is the same as the incident invisible light. The second optical layer can be two or more lenses in one embodiment.

In another illustrative embodiment, the first device comprises a photodiode and the second device comprises a light source. The photodiode can have internal gain. The pixel array can be made from a first plurality of pixels that are configured to receive invisible light of a first wavelength and a second plurality of pixels that are configured to receive invisible light of a second wavelength, where the first wavelength differs from the second wavelength. In an alternative embodiment, each pixel in the pixel array can be configured to receive invisible light of the same wavelength. In an illustrative embodiment, the electrical signal preserves a directionality of the incident invisible light. In another embodiment, the first optical layer directs the incident invisible light to a specific pixel in the pixel array based at least in part on a k-vector of the incident invisible light.

An illustrative method for converting wavelengths includes receiving, by a first optical layer of a wavelength converting system, incident invisible light. The method also includes converting, by a first device in a pixel of a pixel array of the wavelength converting system, the incident invisible light into an electrical signal. The method also includes generating, by a second device in the pixel of the pixel array, visible light corresponding to the electrical signal. The method further includes transmitting, through a second optical layer of the wavelength converting system, the visible light.

In an illustrative embodiment, converting the incident invisible light into the electrical signal includes maintaining a directionality of the incident invisible light such that the electrical signal includes the directionality. Another embodiment includes powering the second device by a battery of the wavelength converting system. Another embodiment includes directing, by the first optical layer, the incident invisible light to a specific pixel in the pixel array based at least in part on a k vector of the incident invisible light. The method can also include generating, based on the visible light, a collimated beam by the second optical layer, where the collimated beam is transmitted from the second optical layer. In an illustrative embodiment, the collimated beam has a direction that is the same as the incident invisible light.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A depicts a wavelength converting goggle in accordance with an illustrative embodiment.

FIG. 1B depicts a wavelength converting contact lens in accordance with an illustrative embodiment.

FIG. 2A is an expanded view of a wavelength converting system in accordance with an illustrative embodiment.

FIG. 2B is a close up view depicting individual pixels for a single wavelength converting system in accordance with an illustrative embodiment.

FIG. 2C is a close up view depicting individual pixels for a multiple wavelength converting system in accordance with an illustrative embodiment.

FIG. 3 is a flow diagram that depicts the process flow for pixel array formation in accordance with an illustrative embodiment.

FIG. 4A depicts an epitaxial layer formed on a substrate in accordance with an illustrative embodiment.

FIG. 4B depicts a pixel pattern formed onto the substrate in accordance with an illustrative embodiment.

FIG. 4C depicts photodiodes etched onto the substrate in accordance with an illustrative embodiment.

FIG. 4D depicts a result of benzocyclobutene (BCB) planarization in accordance with an illustrative embodiment.

FIG. 4E depicts light sources deposited onto the substrate in accordance with an illustrative embodiment.

FIG. 4F depicts an indium tin oxide (ITO) layer grown onto the substrate in accordance with an illustrative embodiment.

FIG. 4G depicts a soft substrate deposited over the ITO layer in accordance with an illustrative embodiment.

FIG. 4H depicts a result of the substrate removal and a back ITO layer deposited on the system in accordance with an illustrative embodiment.

FIG. 5 depicts a system for incoherent conversion of a longer wavelength 24 of light to a shorter wavelength AB with a high spatial resolution (e.g., pixel pitch) in accordance with an illustrative embodiment.

### DETAILED DESCRIPTION

Described herein is technology to produce a thin film of flat or curved form that, when placed in front of the eye, produces an image of objects or radiations that are otherwise invisible to the human eye. The thin film converts the invisible light, which could be x-ray, ultraviolet (UV), infrared, radio waves, etc. to visible light in a manner that preserves the directionality of the incident invisible radiation and as such produces an image of the otherwise invisible object or radiation. As used herein, the term invisible light can refer to any light or radiation that has a wavelength that is less than ˜400 nanometers (nm) or greater than ˜700 nm, such that the light/radiation is outside of what is normally viewable by a human. Similarly, visible light can refer to any light/radiation that has a wavelength of between ˜400 nm-˜700 nm.

The proposed methods and systems of wavelength conversion are based on an array of wavelength-converting pixels that is sandwiched between two optical layers (i.e., transparent conducting layers). Each pixel in the array is made of a stack of two devices: one that converts the invisible light to an electrical signal, and one that converts the electrical signal to visible light. The pixels are electrically powered by a battery. There are two optical layers that sandwich the pixel array. The front optical layer is made of elements that convert the direction of the incident invisible light (known as the k-vectors) to a specific point on the pixel array. A lens is a simple form of such an optical element that can be used to form the front optical layer, but other forms may be used such as a metalens, plasmonic lens, or material geometries inversely designed to achieve the same goal. The second optical layer is used to convert a point of light to a collimated beam with a direction that is the same as the incident invisible light. The second optical layer can be formed using two or more lenses, but also can be implemented using metalenses, metamaterial, plasmonic lenses, and in general any material geometry that is inversely designed to achieve the described performance.

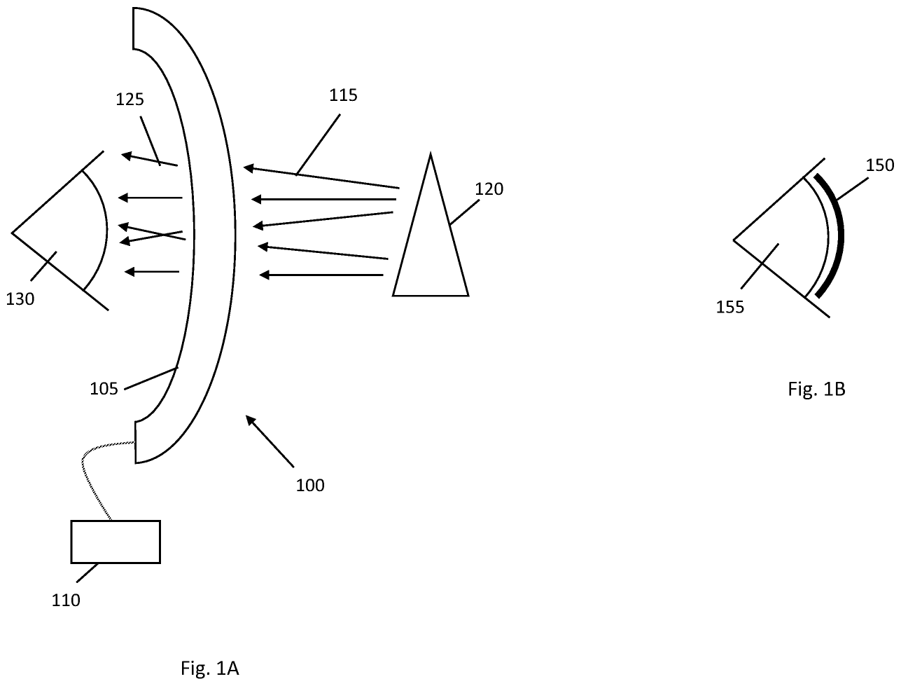

FIG. 1A depicts a wavelength converting goggle 100 in accordance with an illustrative embodiment. The wavelength converting goggle 100 includes a wavelength converting system 105 that is powered by a battery 110. The wavelength converting goggle 100 can also include a frame (not shown) in which the wavelength converting system 105 mounts, one or more straps to secure the system to a user, etc. In one embodiment, the battery 110 can be incorporated into the frame in which the wavelength converting system 105 is mounted.

As described in more detail below, the wavelength converting system 105 includes a first optical layer that receives incident invisible light 115 reflected from an object 120. The first optical layer directs the received incident invisible light 115 to a pixel array, while maintaining the directionality of the incident invisible light. The pixel array, which is sandwiched between the first optical layer and a second optical layer, is used to convert the incident invisible light 115 into an electrical signal and then convert the electrical signal into visible light 125 that is emitted from the second optical layer. As shown, the visible light 125 is directed toward an eye 130 of a user that is wearing the wavelength converting goggle 100.

In an illustrative embodiment, the proposed wavelength converting system 105 can be incorporated into an optical system other than a goggle. As one example, FIG. 1B depicts a wavelength converting contact lens 150 in accordance with an illustrative embodiment. As shown, the wavelength converting contact lens 150 is positioned over an eye 155 of the user, similar to a traditional contact lens. However, unlike a traditional contact lens, the wavelength converting contact lens 150 includes a wavelength converting system along with a battery or other power source to run the system. In another alternative embodiment, the proposed wavelength converting system can be implemented as glasses, binoculars, a telescope, etc.

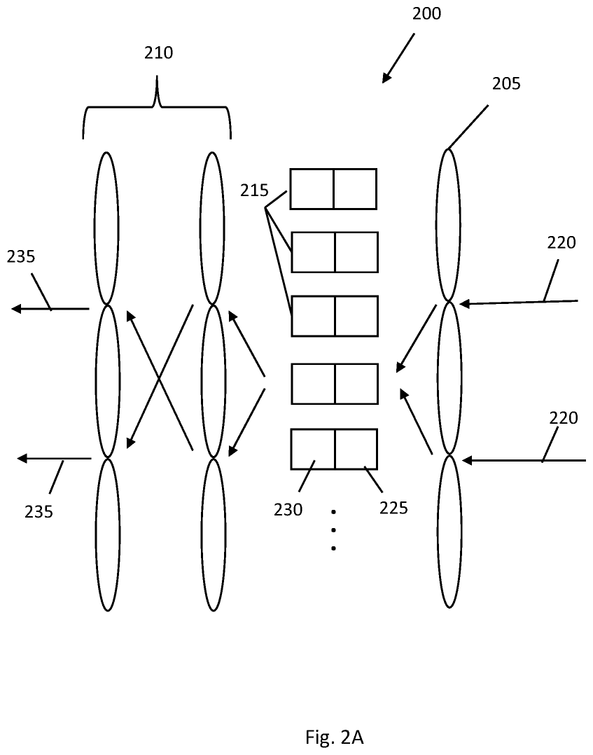

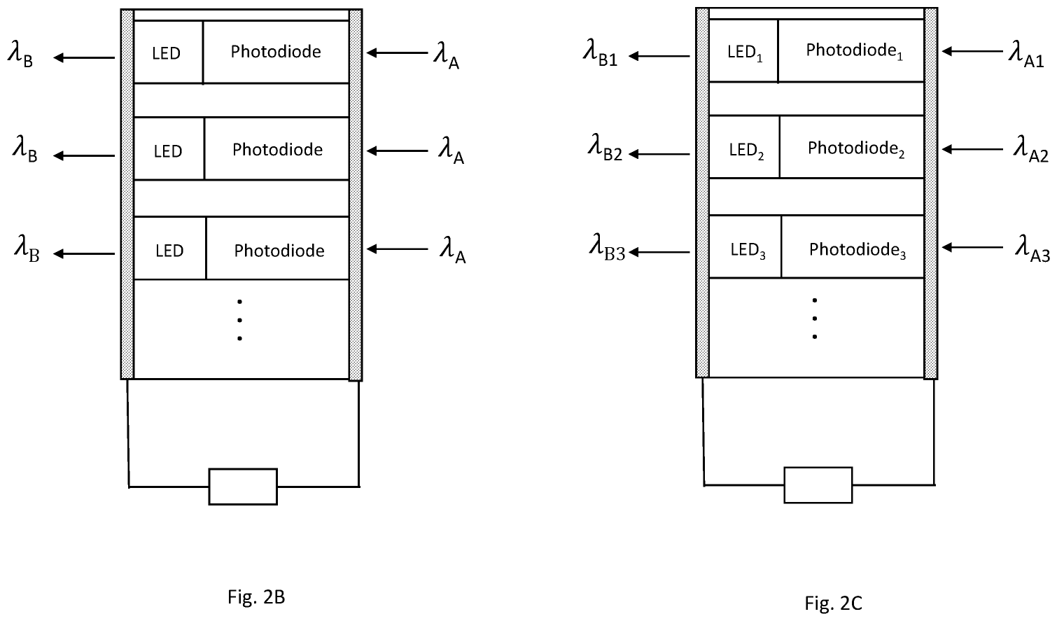

FIG. 2A is an expanded view of a wavelength converting system 200 in accordance with an illustrative embodiment. In one embodiment, the wavelength converting system 200 can be the same as the wavelength converting system 105 depicted in FIG. 1A. Referring to FIG. 2A, the wavelength converting system 200 includes a first optical layer 205, a second optical layer 210, and a pixel array 215 that is positioned between the first optical layer 205 and the second optical layer 210. The first optical layer 205 is positioned on a distal (i.e., furthest from the eye) portion of the wavelength converting system 200, and the second optical layer 210 is positioned on a proximal (i.e., closest to the eye) portion of the wavelength converting system 200.

In an illustrative embodiment, the first optical layer 205 is designed to receive incident invisible light 220, and to direct the incident invisible light 220 to a specific point on the pixel array 215 based on the k-vector (i.e., direction) of the incident invisible light 220. The configuration of the first optical layer 205 controls how the incident invisible light is directed within the system based on light direction. The first optical layer 205 can be a lens array formed from one or more lenses, but can alternatively be formed from a metalens, a plasmonic lens, etc. Once the incident invisible light 220 is directed to the appropriate pixel on the pixel array 215, the pixel converts the incident invisible light 220 into an electrical signal and generates visible light corresponding to the electrical signal. In an illustrative embodiment, the electrical signal preserves the directionality of the incident invisible light 220 such that visible light 235 output by the system has the same directionality as the corresponding invisible light 220 received by the system.

To perform the above-described functions, each pixel in the pixel array 215 includes a first device 225 and a second device 230. In an illustrative embodiment, the first device 225 can be a photodetector with internal gain. Any type of photodetector may be used. In one embodiment, the first device 225 can be a heterojunction phototransistor (HPT). As discussed, the first device 225 converts the incident invisible light 220 into an electrical signal, while preserving the directionality of the incident invisible light 220. The second device 230 is a visible light source and is used to convert the electrical signal generated by the first device 225 into visible light that is directed toward the second optical layer 210. The second device 230 can be any type of visible light source such as a light-emitting diode (LED), an organic LED, etc., and can be powered by a battery.

In an illustrative embodiment, the second optical layer 210 is used to convert a point of light received from the second device 230 to a collimated beam with a direction that is the same as the incident invisible light 220. The second optical layer 210 can be formed using two or more lenses, but also can be implemented using metalenses, metamaterials, plasmonic lenses, etc. Visible light 235 exits the second optical layer 210 and is directed toward the eye of the user. Thus, in use, invisible light/radiation from an object is incident on the wavelength converting system, and the invisible light/radiation is processed by the goggles/glasses/lens into which the system is incorporated such that visible light corresponding to the invisible light/radiation is directed to the eye of the user.

In another illustrative embodiment, the array of wavelength converting pixels can be formed as a single wavelength array or a multi-wavelength array in between the transparent conducting layers. FIG. 2B is a close up view depicting individual pixels for a single wavelength converting system in accordance with an illustrative embodiment. FIG. 2C is a close up view depicting individual pixels for a multiple wavelength converting system in accordance with an illustrative embodiment. In the single wavelength converting system, each of the plurality of pixels includes the same photodiode (with internal gain) and light source (LED in the depicted embodiment). As a result, each pixel receives invisible light λ_{A} and outputs visible light λ_{B}. While only 3 pixels are shown, it is to be understood that the actual system can include any number of pixels arranged in any type of a pattern (e.g., a square or rectangular grid pattern).

In the multiple wavelength converting system of FIG. 2C, different pixels have different photodiodes and light sources that are designed to handle radiation of varying wavelengths. For example, in the embodiment of FIG. 2C, a first pixel is configured to receive invisible light λ_{A1} and to output visible light λ_{B1}, a second pixel is configured to receive invisible light λ_{A2} and to output visible light λ_{B2}, a third pixel is configured to receive invisible light λ_{A3} and to output visible light λ_{B3}, etc. While the embodiment of FIG. 2C depicts 3 different types of pixels corresponding to three different wavelengths, it is to be understood that the system can be designed to convert any number of different wavelengths, such as 2, 4, 5, 6, 10, etc. Additionally, the system can include a plurality of pixels corresponding to each of the different wavelengths converted by the system. As a result, in the multi-wavelength array, different pixels are associated with different wavelengths of light such that the system produces multi-wavelength light that is viewed by the user.

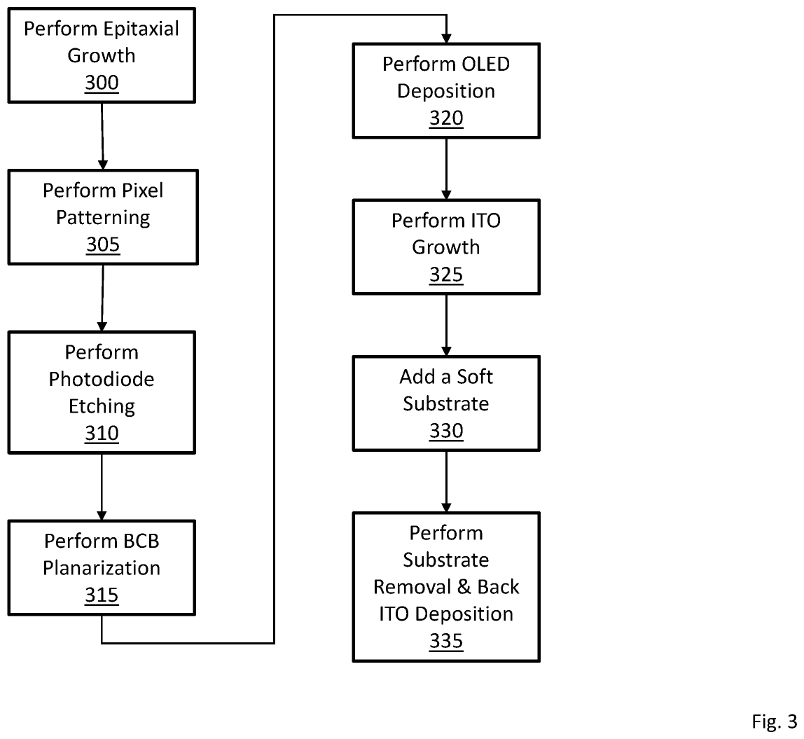

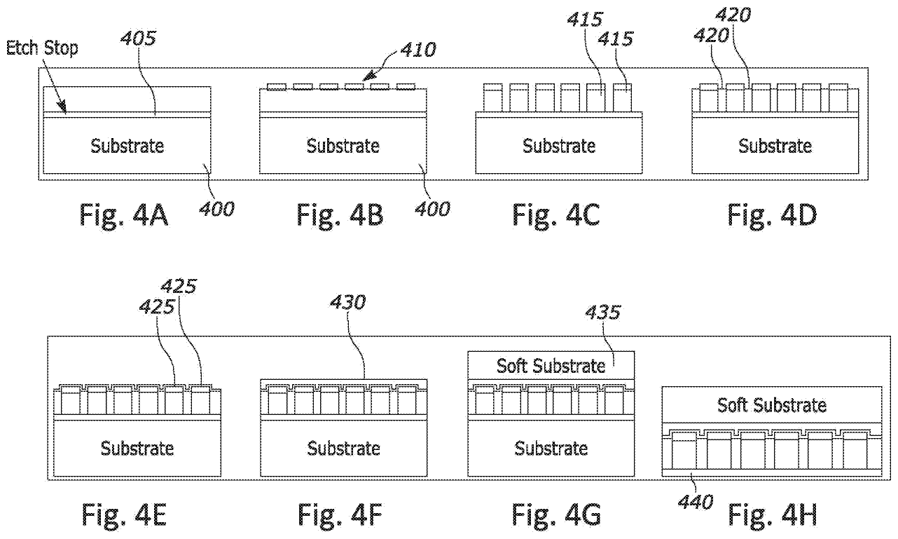

FIG. 3 is a flow diagram that depicts a process flow for pixel array formation in accordance with an illustrative embodiment. In alternative embodiments, fewer, additional, and/or different operations may be used. Also, the use of a flow diagram is not meant to be limiting with respect to the order of operations performed. FIG. 4 is a series of block diagrams that depict results of the various operations described with reference to FIG. 3. The operations of FIG. 3 can be automated and performed by a computing system, or performed manually depending on the implementation. FIGS. 3-4 can be used to construct a relatively flat imager in one embodiment. For a curved imager, it is noted that a similar process could be used with small changes. The deformation from the top of the pixels to the bottom due to the curvature will be very small (e.g., less than 1E-4), which will be absorbed by the benzocyclobutene (BCB) layer that separates individual pixels.

In an operation 300, epitaxial growth is performed. Specifically, an epitaxial layer is formed on a substrate. In an illustrative embodiment, an etch stop procedure can be used to control a depth of the epitaxial layer. FIG. 4A depicts an epitaxial layer 405 formed on a substrate 400 in accordance with an illustrative embodiment. In one embodiment, the epitaxial layer can be indium phosphide. Alternatively, a different compound may be used. In an operation 305, pixel patterning is performed on the substrate. FIG. 4B depicts a pixel pattern 410 formed onto the substrate 400 in accordance with an illustrative embodiment. In an operation 310, photodiode etching is performed. As discussed herein, the photodiode can be designed to have internal gain. FIG. 4C depicts photodiodes 415 etched onto the substrate in accordance with an illustrative embodiment.

In an operation 315, BCB planarization is performed. FIG. 4D depicts a result of benzocyclobutene (BCB) planarization 420 in accordance with an illustrative embodiment. In an operation 320, organic light-emitting diode (OLED) deposition is performed on the substrate to form pixels such that each pixel includes a photodiode (with internal gain) and a light source. Although an OLED is described as one possible light source, it is to be understood that other light sources can be used, such as a regular LED, LCD, etc. FIG. 4E depicts light sources 425 deposited onto the substrate in accordance with an illustrative embodiment.

In an operation 325, indium tin oxide (ITO) growth is performed on the substrate. FIG. 4F depicts an ITO layer 430 grown onto the substrate in accordance with an illustrative embodiment. In an operation 330, a soft substrate is deposited over the ITO layer. FIG. 4G depicts the soft substrate 435 deposited over the ITO layer 430 in accordance with an illustrative embodiment. In an operation 335, substrate removal and back ITO deposition are performed. FIG. 4H depicts a result of the substrate removal and a back ITO layer 440 deposited on the system in accordance with an illustrative embodiment.

In an illustrative embodiment, after the temporary soft substrate is added, the epi substrate (e.g., InP) is removed. At that point, the system includes pixels floating in a soft sea of polymer layers and the whole structure is stretchable. With a radius of curvature of ˜ 40 mm, the deformation from top of the pixels to the bottom is about 0.008% and if the soft substrate is 300 micrometers (um) thick, its deformation is about 0.9%, both of which are well below what is done routinely. A back ITO is deposited on the curved back surface, a permanent soft substrate is deposited, and the temporary soft substrate is removed to form the pixel array of the wavelength converting system.

In another illustrative embodiment, the methods and systems described herein can be used to perform high-throughput broad-band near-field infrared imaging. Near-field imaging has been performed to enhance the resolution of the image significantly better than the diffraction limit. However, the common methods of near-field imaging do not provide a high throughput (in terms of the total number of imaged points per second), and/or broad-band imaging (in terms of the ratio of the sensing wavelength range to the center wavelength). The proposed system allows for sub-diffraction imaging with a far larger number of points per second, and across a far wider optical bandwidth than the state-of-the-art systems and techniques.

The proposed near-field imaging method is based on a detector-emitter pair, where the detector has an internal gain and detects a near-field infrared radiation, converts it to an electrical signal (e.g., current), and modulates the emission of photons from the emitter at a shorter wavelength with this current. The emitted light at the shorter wavelength is no longer sub-diffraction and could be imaged at far-field without the loss of resolution. If the lateral size (or pixel pitch) of the detector-emitter pair is ‘d’, and the wavelength of the detected near-field light is λ_{A} and the wavelength of the emitted infrared light is λ_{B}, then the condition for sub-diffraction imaging of the near-filed is d<=λ_{A}, and the requirement for far-field imaging of the emitted light with a high numerical aperture is d>=λ_{B}. Therefore this application is most useful when λ_{B}<d<λ_{A}.

Existing methods for sub-diffraction near-field imaging are based on either near-field scanning microscopy or the so-called ‘super-lens’ and near-field focusing mirrors, both of which are based on meta-material. There has also been literature regarding near-field photon-pair imaging. The near-field scanning microscopy is a well-established method that can potentially be optically broad-band, but that suffers from a very low throughput. The fundamental reason for the low throughput is the scanning nature of the method, which only allows a serial measurement of each point. There have been efforts to alleviate this issue in the non-optical scanning microscopy using parallel tips with limited success, but the complexity of the system quickly increases with the number of parallel channels, as shown in a published report for a 16 channel lithography system.

The super-lens imaging method is a non-scanning approach and hence with a potential for high throughput. However, this approach is based on three-dimensional meta-material, which inherently requires feature sizes well below the wavelength of light (typically 10 times smaller than the wavelength). While making such feature sizes in a 2D surface is possible using lithography, the 3D realization has remained challenging. There have been some interesting tricks to address the 3D fabrication issue, but these are typically based on a curved surface that inherently limits the field of view (FoV) and hence the total number of points that can be imaged in parallel.

The photon-pair approach is based on spontaneous parametric down conversion (SPDC) in a non-linear optical material. In principle, this method can address the field of view and throughput limitations of the aforementioned approaches. However, there are three inherent limitations in this approach: 1) This approach requires a thin non-linear material to use the near-field effect. This requirement significantly reduces the photon conversion efficiency, and results in a very small signal within a massive optical background. Consequently, the poor signal-to-noise ratio can limit the resolution (this issue is not addressed in the literature surrounding this approach). 2) The optical bandwidth is severely limited by the non-linear process. 3) Detection of externally generated infrared light is not efficient, since homodyne/heterodyne schemes are not possible.

The proposed methods and systems are able to provide both perform high-throughput and broad-band near-field infrared imaging. The proposed system is based on incoherent conversion of a longer wavelength of light λ_{A} to a shorter wavelength λ_{B} with a high spatial resolution (e.g., pixel pitch) of ‘d’. The near-field light is absorbed by the infrared detector and converted to an electrical signal that is then used to modulate the output emitted light of an emitter (e.g., LED, laser, etc.). Since the emitted light has a shorter wavelength, it is possible to image it without the loss of information (e.g., resolution) in the far-field. This imaging method has a unique combination of high throughput (i.e, massive number of parallel channels in excess of billions of channels), can cover a large field of view, and can sense a broadband light near-field source. In an illustrative embodiment, the proposed system can be implemented as a high-density array over a large are (FoV) in excess of several millimeters.

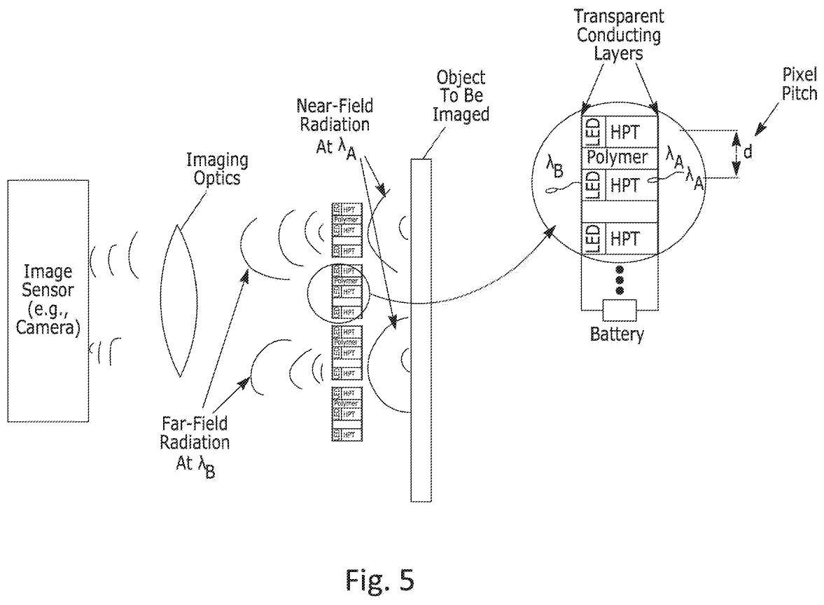

Any of the wavelength converting components (e.g., FIGS. 2A-2C) and/or methods described herein can be used to implement the proposed high-throughput and broad-band near-field infrared imaging system. FIG. 5 depicts such a system. Specifically, FIG. 5 depicts a system for incoherent conversion of a longer wavelength λ_{A} of light to a shorter wavelength λ_{B} with a high spatial resolution (e.g., pixel pitch) in accordance with an illustrative embodiment. As shown, the wavelength converter (as discussed above with reference to FIG. 2) can be designed to have a pixel pitch of ‘d’. An imaging sensor such as a camera includes imaging optics which are used to image an object. Near-field radiation at wavelength JA reflects off of the object being imaged and is received by the wavelength converting system. The wavelength converting system converts the received near-field radiation into an electrical signal and, based on the electrical signal, uses an emitter (e.g., LED, laser, etc.) to output far-field radiation at wavelength λ_{B} that corresponds to the near-field radiation. This far-field radiation is received by the imaging sensor through the imaging optics of the system.

In an illustrative embodiment, any of the operations described herein can be performed at least in part by a computing system that includes a processor, a memory, a user interface, a transceiver (i.e., transmitter and/or receiver), etc. Specifically, the operations described herein can be stored in the memory as computer-readable instructions. Upon execution of the computer-readable instructions by the processor, the computing system performs the operations described herein.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A wavelength converter comprising:
a first optical layer;
a second optical layer; and
a pixel array positioned between the first optical layer and the second optical layer, wherein a pixel in the pixel array includes a first device to convert incident invisible light to an electrical signal and a second device that converts the electrical signal into visible light.

2. The wavelength converter of claim 1, further comprising a battery connected to the pixel array, wherein one or more of the first device and the second device of the pixel is powered by the battery.

3. The wavelength converter of claim 1, wherein the first optical layer is made of one or more elements that convert a direction of the incident invisible light to a specific pixel in the pixel array.

4. The wavelength converter of claim 3, wherein the one or more elements comprise one or more lenses.

5. The wavelength converter of claim 1, wherein the second optical layer is used to convert a point of light to a collimated beam with a direction that is the same as the incident invisible light.

6. The wavelength converter of claim 5, wherein the second optical layer comprises two or more lenses.

7. The wavelength converter of claim 1, wherein the first device comprises a photodiode and the second device comprises a light source.

8. The wavelength converter of claim 7, wherein the photodiode has internal gain.

9. The wavelength converter of claim 1, wherein the first optical layer is configured to receive the incident invisible light.

10. The wavelength converter of claim 1, wherein the second optical layer is configured to output the visible light.

11. The wavelength converter of claim 1, wherein the pixel array comprises a first plurality of pixels that are configured to receive invisible light of a first wavelength and a second plurality of pixels that are configured to receive invisible light of a second wavelength, wherein the first wavelength differs from the second wavelength.

12. The wavelength converter of claim 1, wherein each pixel in the pixel array is configured to receive invisible light of the same wavelength.

13. The wavelength converter of claim 1, wherein the electrical signal preserves a directionality of the incident invisible light.

14. The wavelength converter of claim 1, wherein the first optical layer directs the incident invisible light to a specific pixel in the pixel array based at least in part on a k-vector of the incident invisible light.

15. A method for converting wavelengths, the method comprising:
receiving, by a first optical layer of a wavelength converting system, incident invisible light;
converting, by a first device in a pixel of a pixel array of the wavelength converting system, the incident invisible light into an electrical signal;
generating, by a second device in the pixel of the pixel array, visible light corresponding to the electrical signal; and
transmitting, through a second optical layer of the wavelength converting system, the visible light.

16. The method of claim 15, wherein converting the incident invisible light into the electrical signal includes maintaining a directionality of the incident invisible light such that the electrical signal includes the directionality.

17. The method of claim 15, further comprising powering the second device by a battery of the wavelength converting system.

18. The method of claim 15, further comprising directing, by the first optical layer, the incident invisible light to a specific pixel in the pixel array based at least in part on a k vector of the incident invisible light.

19. The method of claim 15, further comprising generating, based on the visible light, a collimated beam by the second optical layer, wherein the collimated beam is transmitted from the second optical layer.

20. The method of claim 19, wherein the collimated beam has a direction that is the same as the incident invisible light.
